(19) United States
(12) Patent Application Publication
(10) Pub. No.: US 2025/0118148 A1
(43) Pub. Date: Apr. 10, 2025

(54) HYBRID GAMING TABLE WITH DEALER ASSISTANCE

(71) Applicant: Interblock d.o.o., Menges (SI)

(72) Inventors: John Joseph Connelly, Las Vegas, NV (US); Jeffrey Kowalchuk, Las Vegas, NV (US)

(21) Appl. No.: 18/898,220

(22) Filed: Sep. 26, 2024

Related U.S. Application Data
(60) Provisional application No. 63/588,959, filed on Oct. 9, 2023.

(51) Int. Cl. G07F 17/32

(52) U.S. Cl. CPC G07F 17/322; G07F 17/3211; G07F 17/323; G07F 17/3293

(57) ABSTRACT

The present disclosure relates to live, hybrid card gaming systems, methods, and computing devices. Embodiments include a hybrid card gaming table comprising a cabinet having a playing surface defining a gaming area, a plurality of player stations physically connected to the cabinet, a dealer console comprising an interactive user interface configured to receive bet information from the plurality of player stations, a dealer display in communication with the dealer console, a card shoe, and a gaming interface provided at the first player station, and configured to enable a player to participate in live gaming events managed by the dealer console.

### CROSS REFERENCE TO RELATED APPLICATIONS

This application claims benefit under 35 U.S.C. § 119(e) of Provisional U.S. Patent Application No. 63/588,959, filed Oct. 9, 2023, the contents of which is incorporated herein by reference in its entirety.

### TECHNICAL FIELD

The present disclosure relates generally, but not exclusively, to the field of gaming, particularly electronic table games.

### BACKGROUND INFORMATION

Casinos offer a variety of games to attract players. Such games may include live table games (e.g., card, craps, blackjack, etc.), virtual games, physical machines (e.g., slot-like machines and electronic table games), individual player machines, and various gameplay combinations.

Traditional card games often require a highly skilled dealer to manage tables and gaming events. A dealer must supervise and manage bets from one or more players, shuffle and deal multiple hands of cards, quickly determine payouts, and address any disputes or technical issues that arise. As a result, for many card games, the player to dealer ratio is often 6:1 or less. In baccarat, for example, the player to dealer ratio is typically 6:1. In blackjack, the player to dealer ratio is typically 5:1 or 6:1.

The player to dealer ratio can be a limiting factor for card tables and gaming locations that have a high demand and multiple players waiting to play. A live dealer also comes with the potential for human error and payout mistakes, such as where a losing bet is accidentally paid out or more is paid on a winning bet than should have been paid. Casinos and gaming locations operating card tables and live table games must therefore innovate to attract and retain players, maintain profitability, and improve player experience.

### SUMMARY

An embodiment is directed to live card gaming systems, methods, and computer programs. Embodiments include a hybrid card gaming table, including a cabinet comprising a playing surface defining a gaming area, a plurality of player stations physically connected to the cabinet, wherein each of the plurality of player stations comprises a player station display, and wherein each of the plurality of player stations are arranged to enable a player to view the gaming area, a dealer console comprising an interactive user interface configured to receive bet information from the plurality of player stations, provide dealer assistance, and manage payouts related to gaming events, a dealer display in communication with the dealer console, wherein the dealer display provides card information related gaming events, a card shoe configured to shuffle and deal cards, and a gaming interface provided at a first player station display, wherein the gaming interface communicates with the dealer console, and wherein the gaming interface is configured to enable a player to participate in live gaming events.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a perspective view of a hybrid card gaming table, in accordance with an embodiment.

FIG. 2 is dealer-side view of features associated with the hybrid card gaming table of FIG. 1, in accordance with an embodiment.

FIG. 3 is a dealer-side view of interior features associated with the hybrid card gaming table of FIG. 1, in accordance with an embodiment.

FIG. 4A is a front view of a player station, in accordance with an embodiment.

FIG. 4B is a rear view of a player station, in accordance with an embodiment.

FIG. 5 is an example player interface for a player station, in accordance with an embodiment.

FIG. 6 are additional examples of player interfaces and related features, in accordance with an embodiment.

FIG. 7 are example dealer console interfaces, in accordance with an embodiment.

FIG. 8 are example dealer display interfaces, in accordance with an embodiment.

FIG. 9 is an example dealer console interface during card dealing, in accordance with an embodiment.

FIG. 10 is an example dealer console interface to confirm a result, in accordance with an embodiment.

FIG. 11 is an illustration of an exemplary block diagram representing a general-purpose computer system in which aspects of the methods and systems disclosed herein or portions thereof may be incorporated.

### DETAILED DESCRIPTION OF EMBODIMENTS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

Disclosed herein are methods, systems, and non-transitory computer readable storage media that provide a live electronic table game (ETG) for card games. Embodiments include a hybrid card gaming table having a cabinet comprising a playing surface defining a gaming area, a plurality of player stations physically connected to the cabinet, a dealer console a dealer display in communication with the dealer console, a card shoe configured to shuffle and deal cards, and a gaming interface, in communication with the dealer console, provided at a first player station display.

Embodiments may combine the real-time gaming experience of a live dealer with a compact design which allows the product to fit neatly on any casino floor. Embodiments provide an immersive, authentic gaming environment, wherein players may play in real time, receive a live gameplay experience, enhanced by a player station. A gaming cabinet connected to a plurality of player stations may include a computing device (e.g., a dealer console). The computing device may include one or more displays to provide a dealer with essential player information in real-time, provides card dealing information, game overviews, and allows for a more efficient management of games compared to traditional casino tables.

The dealer console may also assist managing aspects of gaming events, including betting windows, card dealing, results determinations, and multiple, alternating gaming events between the gaming areas. As a result, significantly more card gaming events can be played in a given time, with a significantly higher dealer-to-player ratio than traditional card games. In some embodiments, twice the number of games can be played in a same amount of time as at a traditional card table, and the dealer-to-player ratio may be 5:1, 10:1, 50:1, 100:1, 200:1, 230:1, or higher.

In various embodiments, the hybrid gaming table may be operated with a single dealer. An additional person, such as a supervisor, may be present to correct results or resolve errors, although by utilizing player stations and a dealer station to manage game play and resolve bets, the number of corrections and errors that might be required for a traditional live table game are drastically reduced. The dealer station or console and one or more dealer displays may provide a seamless and familiar game flow, with a player experience similar to a traditional, live game. The size may be compact to fit on various gaming and casino floor sizes, designs, and arrangements. For example, the hybrid card gaming table may have a length ranging, for example, from 1125 mm to 2154 mm, a width from 930 mm to 2020 mm, and a height from 780 mm to 1292 mm.

The card gaming table and its gameplay interfaces therefore enable dealer-assisted gameplay for a plurality of players. Players may play on a player station having a display and an interactive interface to place bets. The compact shape and footprint of the card gaming table enable space-saving, efficient placement in a gaming location, such as a casino floor, a pit, a stadium, or a gaming arena. Embodiments may therefore maximize space utilization without compromising the gameplay experience.

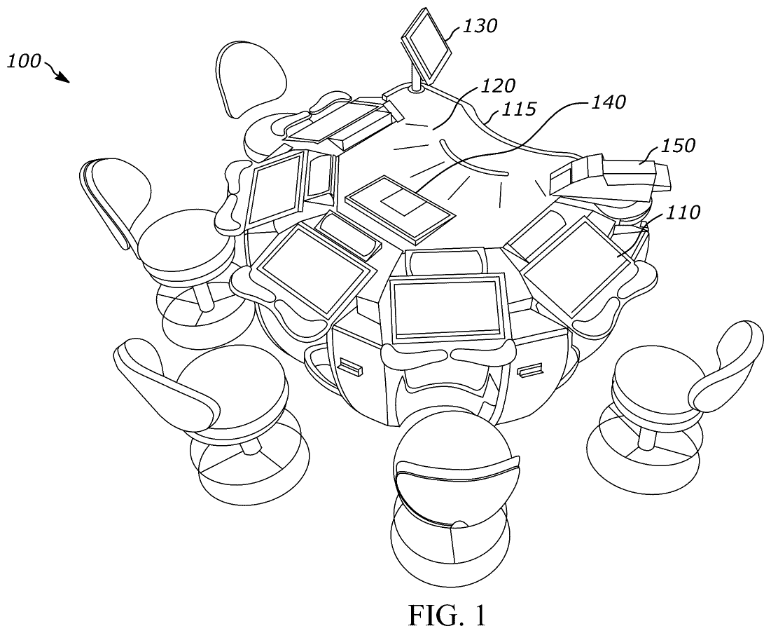

FIG. 1 illustrates an example hybrid card gaming table 100. A plurality of player stations 110 may be arranged around the table, configured to face a dealer station 115, and positioned to be able to view the gaming surface 120, any cards dealt on the gaming surface, and a player display associated with their player station.

A top surface of the gaming table may define a gaming surface. The gaming surface may be a felt surface. Various types of games may be playable at the gaming surface, including Blackjack, Blackjack Xtreme, Baccarat, Dai Bacc, or another type of card game.

The plurality of player stations 110 may include a display device, such as a high-definition touchscreen display. Players may play the game by operating the display device, and do not need to use any hand gestures or verbal announcements to participate in gaming events. Players also do not touch the cards that are dealt or physically bet with gaming chips or tokens and instead only use their display to electronically play the game. This reduces the amount of time required to play each hand, cuts down on damage to the cards, reduces the potential for cheating by players attempting to mark cards, and eliminates players attempting to manipulate their bets during play by adding or removing chips. Because the bets are resolved electronically, dealer mistakes associated with resolving bets are also eliminated. Although infrequent, dealers occasionally collect bets when the player won, pay bets when the player lost, and incorrectly pay winning bets, particularly when there is a blackjack that pays odds other than 1:1 and a player has played an odd amount.

A dealer console 140 includes a display and provides a dealer with essential player information for efficient management of gaming events. In some examples, the dealer console is installed on the gaming surface 120 and may be angled or positioned to be viewable at the dealer station 115, and not viewable at any of the player stations. The dealer console 140 may show gaming instructions and insights, like where next cards need to be dealt, in order to increase gameplay efficiency and allow the dealer to manage the table without having to look away. In some examples, the dealer console 140 includes an LCD display. The dealer console 140 allows the dealer to see which cards have been dealt to each position, without having to look up from the screen. Such features can lead to a more seamless and efficient game flow.

The card gaming table may include at least one dealer display 130 to provide additional gaming information, such as dealt card information, and receive input from the dealer regarding one or more actions, such as dealing a card, confirming a result, opening or closing a betting window, or starting or ending a gaming event. The dealer display 130 may provide information such as a number of active player stations, player information, or gaming information associated with individual player stations.

The at least one dealer display 130 may include a Radiofrequency Identification (RFID) reader to allow a dealer, supervisor, or other employee to log into the game. In some examples, at least one display is configured to display a tournament interface to allow the dealer to manage aspects of a Tournament game. Various interfaces, including live video feeds (e.g., Picture-in-Pictures (PIPs) or Picture-in-Displays (PIDs)), dealer interfaces, and the tournament display interface, may be interchanged between any of the displays at the card gaming table.

A card shoe 150 provided at the hybrid gaming table may store, deal, and/or shuffle cards. The card shoe may be a smart shoe connected and/or operated by a computing device. The card shoe 150 may provide a secure and accurate tracking of dealt cards and may communicate such information to the dealer console and the dealer display. In some examples the card shoe 150 includes a card reader located under a front cover of the shoe. The card shoe may hold up to eight decks of pre-shuffled cards. In some examples, the card shoe may include an automatic card shuffler. An external card shuffler 220 may also be provided at the gaming table. In various embodiments, the card shoe 150 may be located on the top surface of the hybrid gaming table. In other examples, the card shoe may be located behind the table, on the side of the table, or below the top surface of the table. Third-party shoes may be installed on the live gaming table and connected to the computing devices and displays discussed herein.

The hybrid gaming table 100 may further include an interior portion housing at least one computing device, electronics equipment, and control devices. The card gaming table may also include signage or other features to identify the game being played. Signage may also be helpful to attract players and provide other visual or audio effects, such as lighting or artwork.

In some examples, the card gaming table 100 is a curved table, such as a semi-circular table. The plurality of physically connected player stations 110 may be arranged around an outer perimeter of the gaming table. A player side of the card gaming table may be longer than a dealer side 115 of the card table. The player side may be larger to provide space for viewers, players, and/or player stations.

The dealer may stand on one side of the card gaming table (e.g., dealer position 115) so as to view and operate the dealer console 140, view and operate the one or more dealer displays 130, and access the card shoe 150 and deal cards on the gaming surface 120 to execute card gaming events. In some examples, one or more player stations 110 may be provided on an opposite side of the card gaming table. The card gaming table may be used in various gaming locations and environments, such as in casinos.

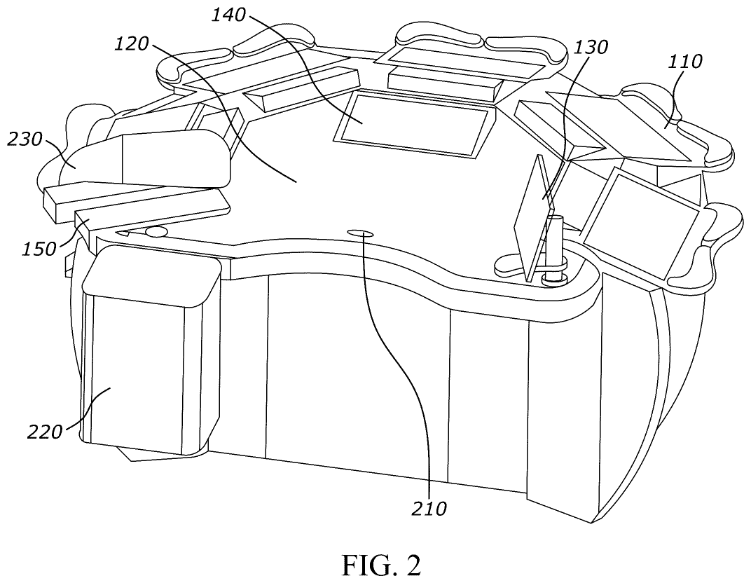

FIG. 2 illustrates a dealer-side view of the hybrid gaming table, including the dealer console 140, dealer display 130, a player station 110, the gaming surface 120, and the card shoe. A protection shield 230 may be provide near the card shoe 150 to prevent a player sitting next to or near the card shoe to see which cards are being pulled from the shoe and being placed on the gaming surface.

A peeker 210 may be provided on the gaming surface of the gaming table. The peeker may include a small mirror installed into the gaming surface to allow the dealer to easily peek at a face down card, without having to bend the cards, to see the current card total and to check for blackjack. A card shuffler 220 may be placed on top or on a side of the live gaming table. The card shuffler 220 may be placed in any position on or near the gaming table, as desired.

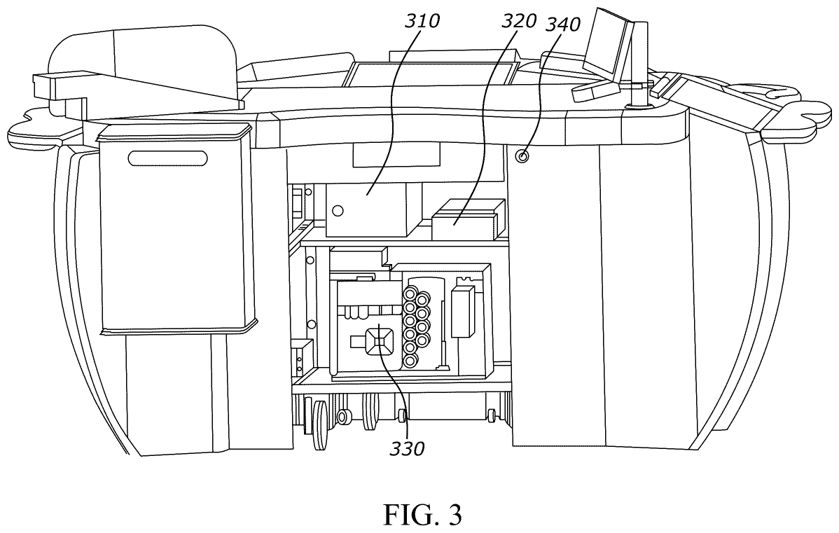

FIG. 3 illustrates a dealer-side view of the gaming table, including an interior portion, which may house one or more computing devices and electronic components. A PID computing device 310, PIP controller 320, electronics box 330, and main power switch 340 may be provided in the interior portion of the housing.

The card gaming table may include an interior portion, such as a hollow portion providing shelves and/or space for electronics and other items. The interior portion may be accessible via one or more doors that enclose and protect components within the interior portion. At least one door may include a door lock to prevent unauthorized access to the interior portion. Other security features, such as an alarm, an RFID reader, or other sensors (e.g., tilt detection sensors, light sensors, etc.) may be added to protect contents within the gaming cabinet, restrict access, and reduce a risk of damage or theft of one or more components of the card gaming table.

The interior portion may include at least one controller for managing aspects of the gaming events, and gaming interfaces. A controller unit may include one or more switches and sensor units for operating any on-table cameras. In some embodiments, at least one camera may capture a video feed of the gaming area, and displayed on at least one of a player display and the dealer. A microphone may be provided to capture audio. The live feed may be a live video feed streamed to the display device to provide a live view of the card gaming area, cards on the table, and gaming events. In an example, the live feed may be provided, via the PIP controller 320, as a PIP on a player display, and as a Picture-in-Display, via the PID computing device 310, on one or more displays associated with the dealer console and dealer display. In a PID, the live video feed may fill an entire display. In PIP, the live video feed may be provided within a portion of a display, such as on a gaming interface and/or overlaid on another image on the display. In some examples a controller unit may include a switch for turning one or both cameras on and off. A sensor unit may, for example, determine one or more environmental conditions (e.g., lighting) to adjust an aspect of the cameras and the video feed.

A PID computing device 310 controller may manage aspects of the one or more visual displays used with the card gaming table. A PID computing device 310 may provide a picture or video within a display. The PID computing device 310 may modify picture or video sizing, resolution, position, and other visual characteristics to fit on displays of various sizes. In an example, the PID computing device 310 include software to operate a Tournament game. The Tournament display may provide a unique interface for player devices, through which players may compete against each other during gaming events, such as one or more card gaming events. The PID computing device 310 may provide additional visual and/or interactive features to connected displays, such as alternate gaming events, advertisements, and information.

A PIP controller 320 may manage aspects of the one or more visual displays used with card gaming table. The PIP controller may include software configured to arrange one or more of images and videos on a player interface and the dealer interface(s). For example, the PIP controller may manage one or more aspects related to video size, position, and resolution on displays. A live video feed, for example, may be provided on a gaming interface, such as overlaid on a betting layout provided on a display on a player station. In some examples, the PIP controller may manage image and video display and placement related to one or more games, jackpots, and tournaments playable with the card gaming table. The PIP controller may be wired or wirelessly connected to other electronics components housed within the gaming cabinet. In some examples, the PIP controller is housed external to the gaming cabinet and communicates with one or more displays and player stations wirelessly.

An electronics box 330 may include a UPS, an electronics module, a gaming unit, and at least one computing device operating software for the card gaming table. Some embodiments may include a gaming unit including at least one gaming controller to operate the card gaming table. The gaming unit may include software configured to at least provide and manage the dealer interface, player interface(s), dealt cards, a result determination, and a wager resolution. The gaming unit may include multiple computing devices, such as a first computing device to operate and manage gaming aspects related to the first card game (e.g., identifying and/or tracking dealt cards) and a second computing device to operate and manage gaming aspects related to the second card game. An electronics box 330 may store one or more electronics components and computing devices within the cabinet.

A power switch 340 may be provided within the interior portion to turn one or more electronics components on and off. In an example, a main power switch controls power to the displays, cameras, card shoes, controllers, and other electronics housed within the gaming cabinet. The power switch 340 may be associated with a power unit that may manage power to and from one or more components of the card gaming table. An uninterruptable power supply (UPS) may be provided to ensure operation in the event of a main power failure.

One or more security features may be provided at the card gaming table. A door lock may lock a door providing access to the interior portion of the gaming cabinet. The front door lock, as discussed herein, may be a physical lock (e.g., requiring a key), an electronic lock (e.g., requiring a scan of an identification card, a passcode entry, or other form of electronic authorization), a magnetic lock, or any other type of device to secure the interior portion and prevent unauthorized access. Similarly, at least one interior lock may be provided to secure one or more components within the gaming cabinet, such as a computer or controller box. Additional security features may be implemented, as needed, on or within the gaming cabinet.

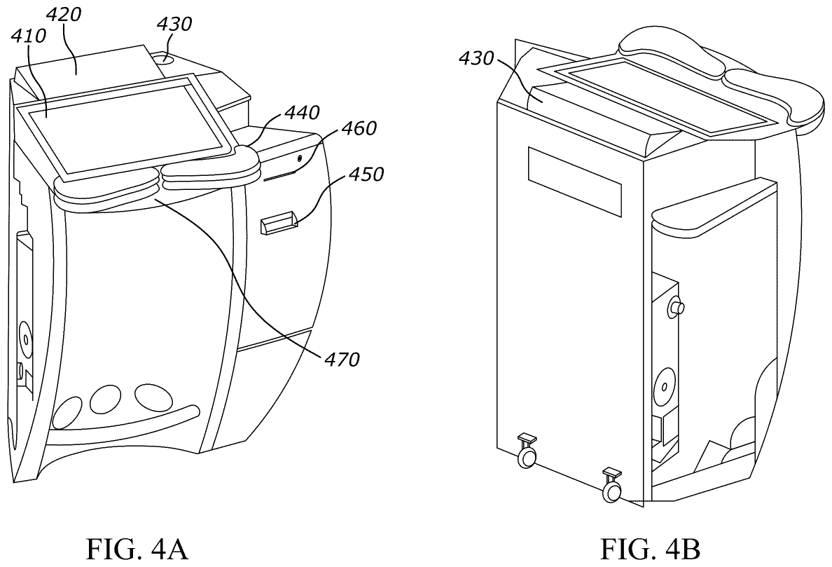

FIGS. 4A-B illustrate, respectively, a front and rear view of an example player station. The player station may include a touch-sensitive display 410 providing the gaming interface through which the player interacts with the game. The touch-sensitive display may be a high definition (HD) or full HD LCD touchscreen.

A player tracking console 420 may be an optional feature to aid with user login and registration when a player begins using the station. The player tracking console may be associated with a reader 430, which may include a contactless RFID card reader. This may be used to access an Operator menu and, if applicable, for cashless credit increment.

The player station may include an armrest 440, such as a color-adjustable illuminated armrest. In some examples, the armrest may be a gel armrest, and may be illuminated with LEDs. In some examples, the color of illumination may be adjusted according to the player's preferences.

A ticket printer and bill/ticket acceptor 450 may be provided to print tickets for credit redemption, and accept bills/tickets to provide additional credit for play.

An LED arc 460 may include changing service lights usable for reporting special game conditions and service or error modes of the player station.

A counter 470 may be optionally provided to contain both mechanical and software counters. In some examples, mechanical counters are mounted on each player station and can display values, such as Bill In, Ticket In, Ticket Out, Hand Pay, Jackpot, Games Played, and Online Play, among others.

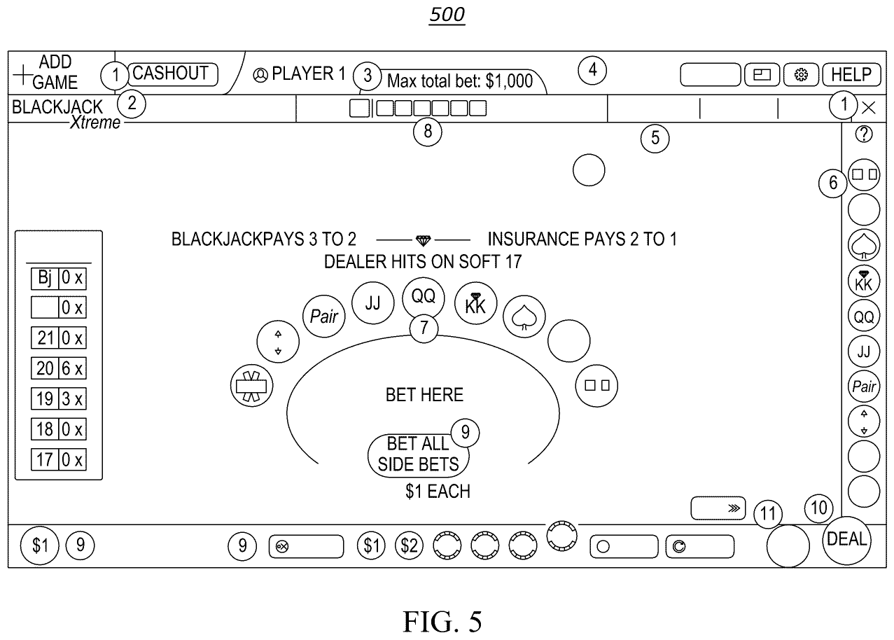

FIG. 5 illustrates an example player interface 500 for a blackjack game. The player interface has at least one betting area to enable play. In some examples the two, three, or more betting areas may be provided to enable a player to play up to three separate hands. The player interface 500 may be provided on a display associated with a player station or other player device, such as a mobile computing device, tablet, or laptop.

A top bar of the player interface may provide a summary regarding the card game and one or more quick-action selections. The top bar may indicate credits, including a “Credit” box indicating a total number of credits, e.g., related to a player account, and a “Playable” box indicating an amount of credits that the player can bet. A “Cash Out” button enables a player to cash out and receive any player credits via ticket printer, a credit add to a player account, or a cash payout from a dealer. The Cash Out selection may only be available when no bets are currently on the table. An add/close game button enables a player to add additional games and change the view of games.

Configurable selections may be provided to enable a player to customize a view of the player interface. For example, an opacity button may be provided to enable a player to reduce the visibility of the player's credits, last bet(s), and the playable amount. A “Main Information” display may provide gaming information, such as when a betting window opens, a time left in the betting window, and when a betting window closes. Error messages may also be provided. A “Call Attendant” or “Concierge” button may signal an attendant of the gaming device, an attendant on the casino floor, or another individual associated with the gaming location and assisting players. A “Tip” button allows sending a tip to the attendant. A “Flag” button may indicate a language used on the interface, and a selection of the button may enable a player to change the interface language. A “Speaker” button enables on/off control of speakers. An “Options” button may bring up a menu that includes additional information about the gameplay or the device. In some examples, the Options menu may include “Reserve Table” to allow a player to reserve a station for an amount of time, a “Show Bet Limits” to display all bet limits for different wagering options, and “Show Winnings,” which will display, as the user places bets, possible winnings for each bet. The possible winnings may be enabled or disabled using a slider or other toggle button. A “Help/Rules” option displays a help screen.

Betting information may be separately provided for each hand or card game. The betting information may indicate a Bet, Last Win, and Last Bet information. A Display Adjustment button allows a player to adjust their gaming layout left and right. One gaming layout may be enlarged while the other is decreased. A history bar on each betting layout will display the last pre-set number of wins corresponding to the respective gaming area.

A betting table provides respective betting layouts including betting fields arranged similarly to a live table. The betting table includes the betting options and combinations. Players may choose one or more selections to assign a bet.

A bet timer provides an indication of whether a betting window is open or closed and may provide a time left for a player to place a bet. A Statistics button may be provided on each betting layout to see respective gaming statistics for each card game. A “Side Bets” button displays information about side bets.

Statistics, such as Dealer Statistics and Player History may provide a number of the most frequent dealer outcomes (Blackjack, bust 21, 20, 19, 18, 17, etc.) in the last pre-set number of games, and a pre-set number of the player's previous results.

Controls enable Denomination, Chips and Game Controls for each respective layout. A Denomination control sets the value of one credit and hence the value of the game. The selected value of one credit may be displayed on the denomination button. The Chips control enables players to select and place chips of different values on the table. Values assigned to chips may be defined with the selected denomination. In some examples, if multi-denomination is disabled, only chips may be available. The Game Control selection may include features to Clear Last Bet, Clear All Bets, Double Bet, Repeat Last Bet, Game Chips, and Fast Bet (i.e., selecting multiple options by dragging a finger across desired fields). A “Copy Bets” button allows a player to copy all of their bets from one layout to the other layout. Bets may be copied manually or automatically. An arrow button, for example, may allow a player to easily copy bets from the left side to the right side or vice versa. If bets are already placed on one game, the “Copy Bets” button may only copy the highest valued bets.

A PIP display provides a live video feed of the card gaming table, in real-time. The live video feed may show all aspects of the gaming event in real-time, including but not limited to, a start of the gaming event, card flips, hands, and a gaming event result. The PIP display may be enlarged or minimized using an arrow button. The PIP display may also be moved and locked to a desired position.

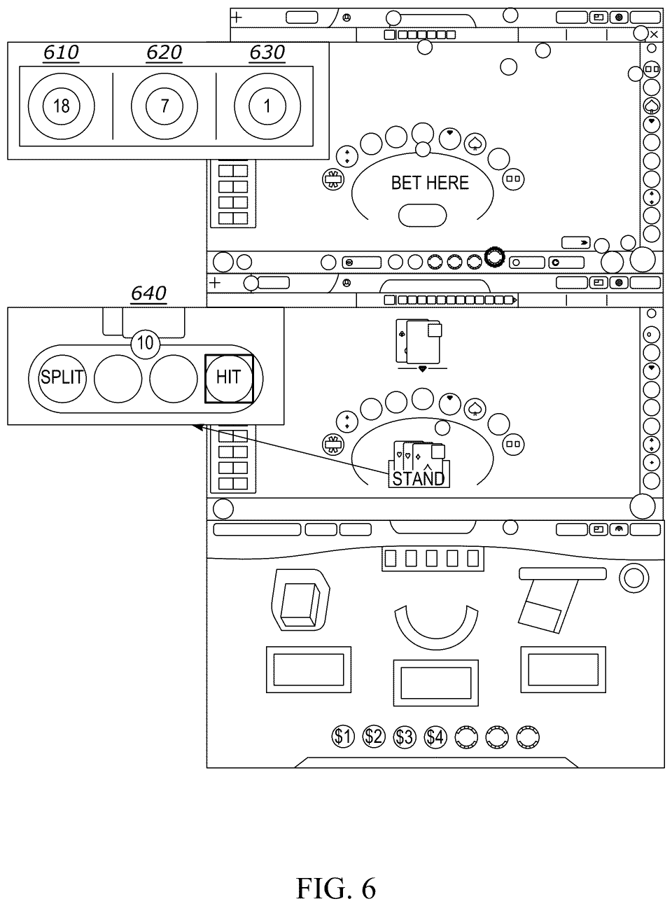

FIG. 6 illustrates additional blackjack betting layout examples and features. Betting indicators 610, 620, 630 may provide information regarding whether a betting window is open or closed, and to help a player to quickly determine where and when to place bets. A first indicator 610 may be provided in a first color (e.g., green) to indicate that a betting window is open. The indicator 610 may also provide text (e.g., “Place Your Bets”) and a time left in the open betting window. A second indicator 620 may be provided in a second color (e.g., yellow) to indicate that a betting window is closing soon. The indicator 620 may also provide text (e.g., “Last Bets Please”) and the time left in the open betting window. A third indicator 630 may be provided in a third color (e.g., red) to indicate that betting window has minimal time left and/or that a betting window is closed. The indicator 630 may also provide text (e.g., “Last Bets Please” or “No More Bets”), any time left in the betting window, or a time until a new betting window is opened. A Win Amount (e.g., $10.00) may be displayed on the interface following a gaming event. The Win Amount may be displayed using one or more colors and animations on the display.

A set of buttons 640 on the player interface may provide options for a player to take an action with respect to the gaming event. In a blackjack gaming example, the action may be to split, double down, stand, or hit. The set of buttons 640 may be provided for each active hand being played and may provide a countdown or other indicator representing how much time is left in a betting window for a user to take action.

As seen in the bottom screen, a multiplayer blackjack game may be provided on a user interface. A player may separately bet on two or more hands, which may be dealt on the gaming surface. The player interfaces may also provide interfaces for single player and multiplayer options. For example, the interfaces may provide options to add games (e.g., up to four games), close games, and change the way the games are displayed. The player interface may provide gaming and interface controls, such as cashout, credit meter, credit opacity, call concierge/attendant, flags, sounds, options, show winnings, bet values, and help.

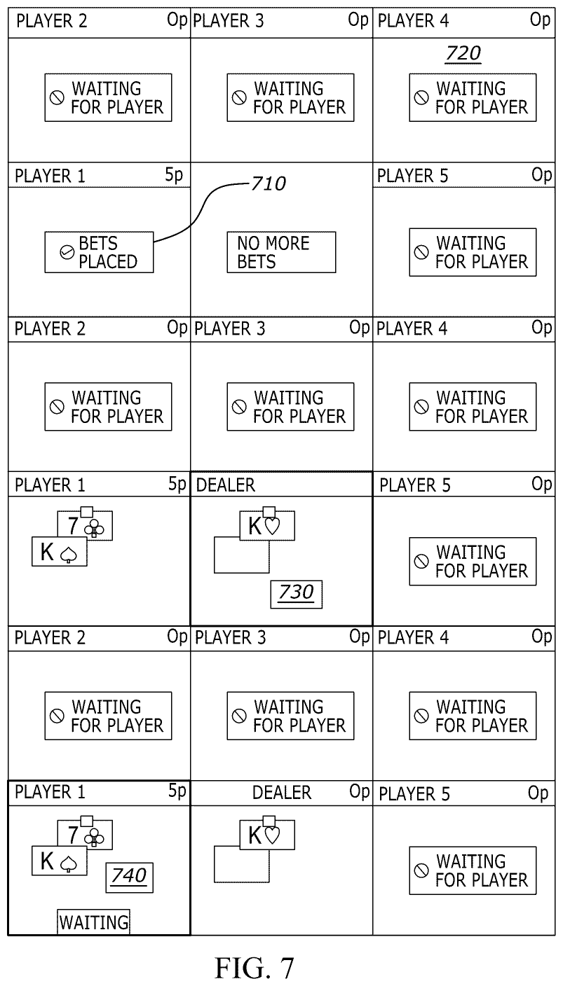

FIG. 7 illustrates various examples of dealer console interfaces during game play. The dealer display may show separate areas representing each of the plurality of player stations connected to the gaming table. The areas may be labeled with a player identifier, such as a player name or a player number. An indicator, which may include color and/or text, may indicate a current bet status. Indicator 710 shows a green bet status noting “Bets Placed,” while indicator 720 shows a red bet status noting “Waiting for Player.”

A dealer area may indicate a current status of a betting window (e.g., open, closed, no more bets, etc.) or a current timer associated with the betting window. The dealer section may also show a current hand for the dealer.

In some examples, a player area or the dealer area may be highlighted to indicate, for example, where a card is being dealt, or where a next action should be taken. At box 730, a dealer area is highlighted to indicate that a next action will be a card dealt to the dealer. In some examples the next action may require a selection at the dealer console or the dealer display. As seen in box 740, a highlighted box may indicate that a next action is being, or will be, taken by a player. A “waiting” status identifier may indicate that an action, such as a bet placement, or decision is pending.

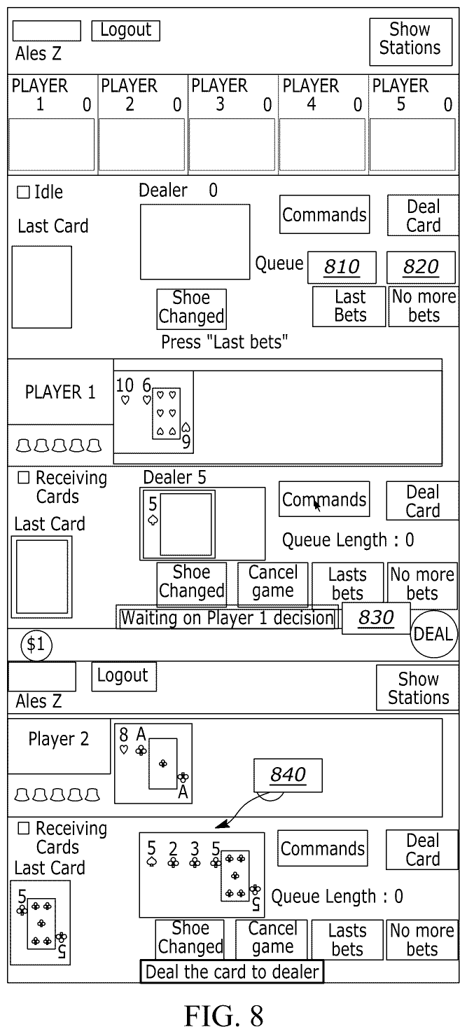

FIGS. 8-10 illustrate various dealer display interfaces. As discussed herein, the dealer display is provided on a display provided at the card gaming table. Dealer displays may be connected to one or more of the card shoe, the dealer console, the player station, a card reader, and a separate computing device, which runs an independent dealer interface. The computing devices may communicate information regarding dealt hands and gaming events occurring at the card gaming table.

FIG. 8 illustrates three example dealer display views, which may be toggled during gameplay. A first interface may provide an overview of active player stations, and provide separate information, in a separate area, for each player station. For example, a green box, for example, may indicate an active player station, while a greyed out box may indicate that there is no active player at that player station position. The overview may further include a summary indicating a total number of players, a number of players with credit, a number of players placing a bet, a total bet, a current time, a login time, and a time of play. Other information may include dealer information, a last card, a current card, and a set of selections, including but not limited to show stations, commands, deal card, last bets, no more bets, and shoe changed. In some examples, a Last Bets button 810 may initiate a notification at the player stations indicating a countdown timer or other indication that the betting will be closing soon. A No More Bets button 820 may close the betting window.

A selection of an active player, e.g., Player 1 or Player 2, may respectively bring up the Player 1 interface and the Player 2 interface. A current hand may be provided on a top portion of the screen, and a Dealer hand 840 may be provided in a center portion of the screen. A next step indicator 830 may be provided at a bottom portion of the dealer display. The next step indicator 830 may be an action for the dealer, e.g., “Deal the card to Dealer,” “Deal Card to Player,” etc. In another example the next step indicator may note that a next step is a player action, such as a player bet, or a decision on how to play their hand. The player action or dealer action may be performed, and the next step is automatically determined and updated at the next step indicator.

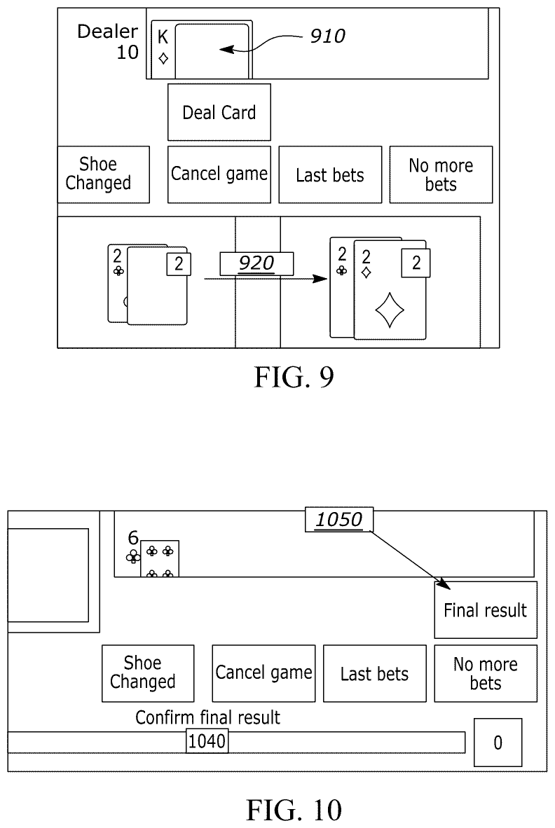

FIG. 9-10 illustrate additional dealer interfaces that may occur when a dealer is running a card game. In some examples, a dealer number associated with a dealer identification (e.g., Dealer 10) may be provided on the interface. A dealer hand 910 area indicates a dealer hand for a game, and a card selection, such as “Deal Card” will cause a new card to be dealt and updated at the dealer hand 910 area. In some examples, “Deal Card” may cause a card shoe to deal a card, and a card reader located at or near the card shoe may communicate the card value to the dealer console and reflected on the dealer interface. In some examples, the dealer must select the face down card to deal a new card for a player 920. This selection will also deal a card and update the card at the player interface. Other dealer options at the interface include selections for “Shoe Changed,” “Cancel Game,” “Last Bets,” and “No More Bets.”

When a round ends, a “Final Result” selection 1050 may be required to confirm results and/or initiate payouts. Dealer Instructions 1040 may be provided at the bottom of the dealer interface, as needed, to keep the game progressing. For example, a message area 1040 positioned at the bottom of the dealer interface may indicate instructions and/or a next step required before a next game may proceed.

In the Results area, a temporary result may automatically populate when a hand is dealt and/or when a gaming event is finished. The temporary result may be determined at the dealer console, using one or more sensors associated, e.g., with the card shoe. A dealer must confirm the result prior to a next gaming event begins. The dealer confirmation helps safeguard against errors, such as mechanical and/or detection errors, which might provide a mistaken result.

In an example Blackjack gameplay flow, a player may join a live card table game by logging in to a player account and/or adding credits to a player station. Credits will be displayed on the player interface.

The dealer console may automatically update as players join at the player stations associated with the card gaming table. The player station display may provide the gaming interface, and a player may select one or more bets during the open betting window. At the dealer display, a dealer may select a button (e.g., “Last Bets”) to inform players that the open betting window will close soon. The gaming interface at the player station may show “Place Your Bets” to inform the player of the closing betting window. During the betting window, at least one of the dealer display and the dealer console may show which players have placed their bets.

The dealer may then select a button (e.g., “No More Bets”) to close the betting window. In some examples, the betting window closes automatically, after a given time has expired. In other examples, the betting window closes automatically when a card or hand is dealt, such as when the dealer selects a deal command at the dealer interface, or when the dealer pulls a first card out of the card shoe. The dealer may also be prompted, on the dealer display, to deal the cards to the active player stations.

In a Blackjack or Blackjack Xtreme game, a pair of cards are interchangeably dealt to the player's hand and to the dealer's hand. A player then selects a gaming action (e.g., split, double down, stand, and hit) on the gaming interface of the player station. The gaming action may have a limited time (e.g., 10, 15, 20 seconds, etc.) to make a decision. After the player makes a decision or the decision timer runs out, additional player cards are dealt. The decision process repeats until the player decides to stand or their hand busts. In gaming events, such as during Blackjack Xtreme, where more than one hand may require a decision during a gaming event, the player repeats the decision process for each hand separately.

The dealer then flips the card facing down on the table. In some examples, this may also require a selection on the dealer interface (e.g., selecting a face down card) to flip the card. The dealer interface selection will turn the card displayed on the player interfaces, and the physically drawn card will automatically be provided on the player interfaces. The dealer will then draw new cards until a value (e.g., 17 or higher) is reached, or until a bust. The dealer then taps “Final Result” on the dealer interface, and results are announced on player interfaces.

During gaming events, in addition to making selections on the dealer display, the dealer deals physical cards from the card shoe and places them on respective playing fields on the card gaming table. The dealt cards are displayed on the player interface in real-time using one or more sensors and card readers, which may be associated with the card shoe. Once the dealer deals the required number of cards to each betting position, the results are declared and displayed on the player interface. A player win may initiate a winning animation on the player interface.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

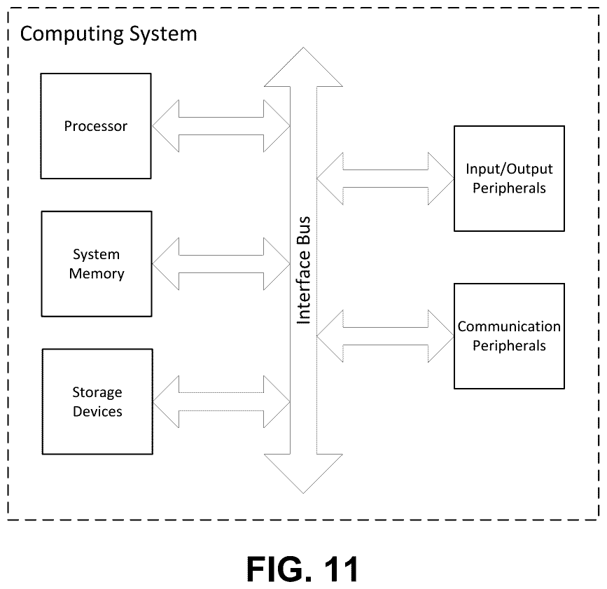

The techniques described above can be implemented on a computing device associated with a gaming device (e.g., a card machine operating a live card game), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, the techniques may be distributed between the computing device(s) and the controller(s). FIG. 11 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including card shoe operations, adjustments and result detection optimization, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

In an embodiment, a hybrid card gaming table, comprising: a cabinet comprising a playing surface defining a gaming area; a plurality of player stations physically connected to the cabinet, wherein each of the plurality of player stations comprises a player station display, and wherein each of the plurality of player stations are arranged to enable a player to view the gaming area; a dealer console comprising an interactive user interface configured to receive bet information from the plurality of player stations, provide dealer assistance, and manage payouts related to gaming events; a dealer display in communication with the dealer console, wherein the dealer display provides card information related gaming events; a card shoe configured to shuffle and deal cards; and a gaming interface provided at a first player station display, wherein the gaming interface communicates with the dealer console, and wherein the gaming interface is configured to enable a player to participate in live gaming events.

In an embodiment, wherein the card shoe is a smart shoe in communication with the dealer console, and wherein a card drawn from the smart shoe is automatically read and displayed on at least one of the dealer display and the gaming interface.

In an embodiment, wherein a selection at the dealer console defines a betting window indicating at least one of: a time left to accept bets, no more bets being accepted, and at least one gaming event result, wherein information relating to the betting window is reflected on the gaming interface.

In an embodiment, wherein the gaming interface at the player station is configured to accept a bet during the betting window defined at the dealer console.

In an embodiment, wherein the gaming interface is configured to provide real-time card information associated with at least one of a dealer hand and a player hand.

In an embodiment, wherein the plurality of player stations include five player stations, each comprising a player display, and arranged in a semi-circle around a perimeter of the gaming area.

In an embodiment, wherein the gaming interface comprises a plurality of selections representing at least one type of bet and an amount to bet.

In an embodiment, wherein the betting layout further comprises a plurality of areas representing individual hands playable against a dealer hand.

In an embodiment, wherein the dealer display displays, in real time, a current bet status for each of the plurality of player stations.

In an embodiment, wherein during a gaming event, the dealer display provides instructions regarding an action to be performed at the dealer console to operate the gaming event.

In an embodiment, wherein the action comprises a selection to cause at least one of: dealing a card, confirming a result of a hand, resolve a bet, open a betting window, close a betting window, and provide a notification to at least one player station.

In an embodiment, wherein, during a gaming event, the dealer display provides information related to each of the plurality of player stations actively playing.

In an embodiment, wherein the dealer display highlights an area associated with a player station requiring an action to be taken.

In an embodiment, wherein the cabinet comprises an interior portion for housing electronic components.

In an embodiment, wherein the playing surface is a felt surface comprising a design to play blackjack, baccarat, dai bacc, or another card game.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed is:

1. A hybrid card gaming table, comprising:
a cabinet comprising a playing surface defining a gaming area;
a plurality of player stations physically connected to the cabinet, wherein each of the plurality of player stations comprises a player station display, and wherein each of the plurality of player stations are arranged to enable a player to view the gaming area;
a dealer console comprising an interactive user interface configured to receive bet information from the plurality of player stations, provide dealer assistance, and manage payouts related to gaming events;
a dealer display in communication with the dealer console, wherein the dealer display provides card information related gaming events;
a card shoe configured to shuffle and deal cards; and
a gaming interface provided at a first player station display, wherein the gaming interface communicates with the dealer console, and wherein the gaming interface is configured to enable a player to participate in live gaming events.

2. The hybrid card gaming table of claim 1, wherein the card shoe is a smart shoe in communication with the dealer console, and wherein a card drawn from the smart shoe is automatically read and displayed on at least one of the dealer display and the gaming interface.

3. The hybrid card gaming table of claim 1, wherein a selection at the dealer console defines a betting window indicating at least one of: a time left to accept bets, no more bets being accepted, and at least one gaming event result, wherein information relating to the betting window is reflected on the gaming interface.

4. The hybrid card gaming table of claim 3, wherein the gaming interface at the player station is configured to accept a bet during the betting window defined at the dealer console.

5. The hybrid card gaming table of claim 1, wherein the gaming interface is configured to provide real-time card information associated with at least one of a dealer hand and a player hand.

6. The hybrid card gaming table of claim 1, wherein the plurality of player stations include five player stations, each comprising a player display, and arranged in a semi-circle around a perimeter of the gaming area.

7. The hybrid card gaming table of claim 1, wherein the gaming interface comprises a plurality of selections representing at least one type of bet and an amount to bet.

8. The hybrid card gaming table of claim 7, wherein the betting layout further comprises a plurality of areas representing individual hands playable against a dealer hand.

9. The hybrid card gaming table of claim 1, wherein the dealer display displays, in real time, a current bet status for each of the plurality of player stations.

10. The hybrid card gaming table of claim 1, wherein during a gaming event, the dealer display provides instructions regarding an action to be performed at the dealer console to operate the gaming event.

11. The hybrid card gaming table of claim 10, wherein the action comprises a selection to cause at least one of: dealing a card, confirming a result of a hand, resolve a bet, open a betting window, close a betting window, and provide a notification to at least one player station.

12. The hybrid card gaming table of claim 1, wherein, during a gaming event, the dealer display provides information related to each of the plurality of player stations actively playing.

13. The hybrid card gaming table of claim 11, wherein the dealer display highlights an area associated with a player station requiring an action to be taken.

14. The hybrid card gaming table of claim 1, wherein the cabinet comprises an interior portion for housing electronic components.

15. The hybrid card gaming table of claim 1, wherein the playing surface is a felt surface comprising a design to play blackjack, baccarat, dai bacc, or another card game.
